(19) United States
(12) Patent Application Publication
(10) Pub. No.: US 2023/0039239 A1
(43) Pub. Date: Feb. 9, 2023

(54) CONSEQUENT POLE ROTOR, MOTOR, FAN, AND AIR CONDITIONER

(71) Applicant: Mitsubishi Electric Corporation, Tokyo (JP)

(72) Inventors: Takanori WATANABE, Tokyo (JP); Hiroki ASO, Tokyo (JP); Kazuchika TSUCHIDA, Tokyo (JP); Takaya SHIMOKAWA, Tokyo (JP); Ryogo TAKAHASHI, Tokyo (JP)

(21) Appl. No.: 17/792,006

(22) PCT Filed: Feb. 27, 2020
(86) PCT No.: PCT/JP2020/008009

§ 371 Date: Jul. 11, 2022

(51) Int. Cl. H02K 1/276; H02K 7/00; H02K 21/16

(52) U.S. Cl. CPC H02K 1/2766; H02K 7/003; H02K 21/16; F24F 1/0022

(57) ABSTRACT

A rotor is a consequent pole rotor. The rotor includes a first magnetic pole region functioning as a first magnetic pole, a second magnetic pole region functioning as a second magnetic pole that is a pseudo-magnetic pole, a shaft disposed in a shaft insertion hole, and a nonmagnetic member coupling the shaft to the rotor core. The nonmagnetic member includes a beam extending from the shaft to the second magnetic pole region.

### CROSS REFERENCE TO RELATED APPLICATION

This application is a U.S. national stage application of International Patent Application No. PCT/JP2020/008009 filed on Feb. 27, 2020, the disclosure of which is incorporated herein by reference.

### TECHNICAL FIELD

The present disclosure relates to a rotor of a motor.

### BACKGROUND

A consequent pole rotor has been employed to reduce the amount of permanent magnets use in a rotor for a motor. For example, in a consequent pole rotor described in Patent Reference 1, for example, a gap between a shaft and each magnet insertion hole is filled with a resin. This configuration can reduce magnetic flux leakage from the permanent magnets to the shaft.

### PATENT REFERENCE

Patent Reference 1: International Patent Publication No. 2018/037449

In the consequent pole rotor illustrated in FIG. 19 of Patent Reference 1, for example, a rib-shaped resin is disposed between each magnet insertion hole and the shaft. In this case, when the resin expands because of a temperature change, stress is concentrated on a rotor core between the resin and the permanent magnets. Consequently, the magnet insertion holes might be deformed, and thus permanent magnets disposed in the magnet insertion holes are damaged.

### SUMMARY

It is therefore an object of the present disclosure to prevent deformation of magnet insertion holes to avoid damage of permanent magnets disposed in the magnet insertion holes.

A consequent pole rotor according to an aspect of the present disclosure is a consequent pole rotor including: a rotor core having a magnet insertion hole and a shaft insertion hole; a permanent magnet disposed in the magnet insertion hole; a first magnetic pole region including the magnet insertion hole and functioning as a first magnetic pole; a second magnetic pole region adjacent to the first magnetic pole region and functioning as a second magnetic pole, the second magnetic pole being a pseudo-magnetic pole; a shaft disposed in the shaft insertion hole; and a nonmagnetic member disposed in the shaft insertion hole, having a linear expansion coefficient larger than a linear expansion coefficient of the rotor core, and coupling the shaft to the rotor core. The nonmagnetic member includes a beam extending from the shaft to the second magnetic pole region.

A motor according to another aspect of the present disclosure including: the consequent pole rotor; and a stator disposed outside the consequent pole rotor.

A fan according to another aspect of the present disclosure including: a blade; and the motor to drive the blade.

An air conditioner according to another aspect of the present disclosure including: an indoor unit; and an outdoor unit connected to the indoor unit. One or both of the indoor unit and the outdoor unit include the motor.

According to the present disclosure, it is possible to prevent deformation of magnet insertion holes to avoid damage of permanent magnets disposed in the magnet insertion holes.

### BRIEF DESCRIPTION OF THE DRAWINGS

FIG. 1 is a partial cross-sectional view schematically illustrating a configuration of a motor according to a first embodiment.

FIG. 2 is a cross-sectional view schematically illustrating a configuration of the motor.

FIG. 3 is a cross-sectional view schematically illustrating a configuration of a rotor.

FIG. 4 is a cross-sectional view schematically illustrating the configuration of the rotor.

FIG. 5 is a diagram illustrating another example of the rotor.

FIG. 6 is a diagram illustrating yet another example of the rotor.

FIG. 7 is a diagram illustrating still another example of the rotor.

FIG. 8 is a diagram illustrating still another example of the rotor.

FIG. 9 is a cross-sectional view illustrating a rotor as a comparative example.

FIG. 10 is a diagram illustrating stress occurring in a rotor core when beams expand in the rotor as the comparative example.

FIG. 11 is a diagram illustrating displacement of the rotor core when the beams expand in the rotor as the comparative example.

FIG. 12 is a diagram illustrating stress occurring in a rotor core when beams expand in the rotor in the first embodiment.

FIG. 13 is a diagram illustrating displacement of the rotor core when the beams expand in the rotor in the first embodiment.

FIG. 14 is a diagram illustrating stress occurring in a rotor core when beams expand in a rotor in a third variation.

FIG. 15 is a diagram illustrating displacement of the rotor core when the beams expand in the rotor in the third variation.

FIG. 16 is a diagram schematically illustrating a configuration of a fan according to a second embodiment.

FIG. 17 is a diagram schematically illustrating a configuration of an air conditioner according to a third embodiment.

FIG. 18 is a diagram schematically illustrating main components in an outdoor unit as an air blower of the air conditioner.

### DETAILED DESCRIPTION

### First Embodiment

A motor 1 according to a first embodiment will be described.

In an xyz orthogonal coordinate system shown in each drawing, a z-axis direction (z axis) represents a direction parallel to an axis Ax of the motor 1, an x-axis direction (x axis) represents a direction orthogonal to the z-axis direction (z axis), and a y-axis direction (y axis) represents a direction orthogonal to both the z-axis direction and the x-axis direction. The axis Ax is a rotation center of a rotor 2, that is, a rotation axis of the rotor 2. The direction parallel to the axis Ax will also be referred to as an “axis direction of the rotor 2” or simply an “axis direction.” The radial direction refers to a direction of a radius of the rotor 2 or a stator 3, and is a direction orthogonal to the axis Ax. An xy plane is a plane orthogonal to the axis direction. An arrow Dl represents a circumferential direction about the axis Ax. A circumferential direction of the rotor 2 or the stator 3 will also be simply referred to as a “circumferential direction.”

### <Motor 1>

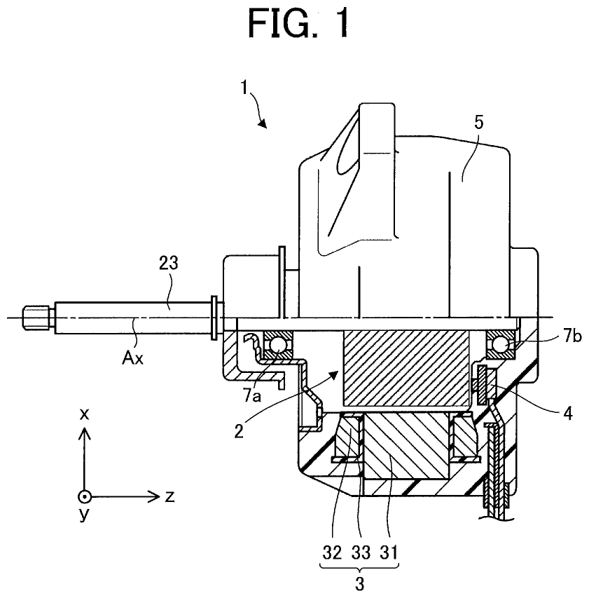

FIG. 1 is a partial cross-sectional view schematically illustrating a configuration of the motor 1 according to the first embodiment.

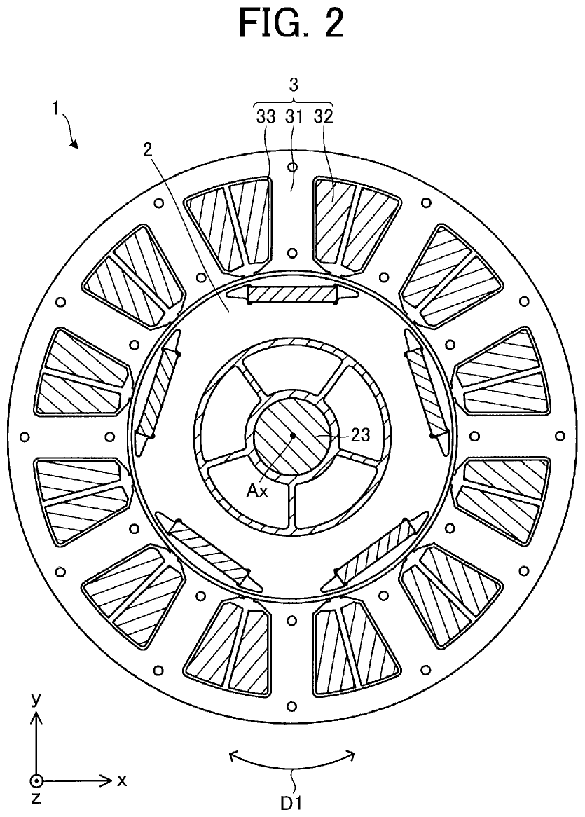

FIG. 2 is a cross-sectional view schematically illustrating a configuration of the motor 1.

The motor 1 includes the rotor 2, the stator 3, a circuit board 4, a molding resin 5, and bearings 7a and 7b for rotatably retaining the rotor 2. The motor 1 is, for example, a permanent magnet synchronous motor such as an interior permanent magnet motor (IPM motor).

### <Stator 3>

The stator 3 is disposed outside the rotor 2. The stator 3 includes a stator core 31, a coil 32, and an insulator 33. The stator core 31 is a ring-shaped core including a ring-shaped core back and a plurality of teeth extending in the radial direction from the core back.

The stator core 31 is composed of, for example, a plurality of thin iron magnetic sheets. In this embodiment, the stator core 31 is composed of a plurality of electromagnetic steel sheets stacked in the axis direction. Each of the electromagnetic steel sheets of the stator core 31 has a thickness of 0.2 mm to 0.5 mm, for example.

The coil 32 (i.e., winding) is wound around the insulator 33 attached to the stator core 31. The coil 32 is insulated by the insulator 33. The coil 32 is made of a material containing copper or aluminium, for example.

The insulator 33 is made of, for example, an insulative resin such as polybutylene terephthalate (PBT), polyphenylene sulfide (PPS), liquid crystal polymer (LCP), or polyethylene terephthalate (PET). The resin insulator 33 is, for example, an insulating film having a thickness of 0.035 mm to 0.4 mm.

For example, the insulator 33 is shaped integrally with the stator core 31. It should be noted that the insulator 33 may be shaped separately from the stator core 31. In this case, after the insulator 33 has been shaped, the insulator 33 is fitted in the stator core 31.

In this embodiment, the stator core 31, the coil 32, and the insulator 33 are covered with the molding resin 5. The stator core 31, the coil 32, and the insulator 33 may be fixed by a cylindrical shell made of a material containing iron, for example. In this case, the stator 3 is covered with a cylindrical shell by shrink fitting together with the rotor 2, for example.

The circuit board 4 is fixed by the molding resin 5 together with the stator 3. The circuit board 4 includes a driving device for controlling the motor 1.

The molding resin 5 unites the circuit board 4 and the stator 3 together. The molding resin 5 is, for example, a thermosetting resin such as a bulk molding compound (BMC) or an epoxy resin.

### <Rotor 2>

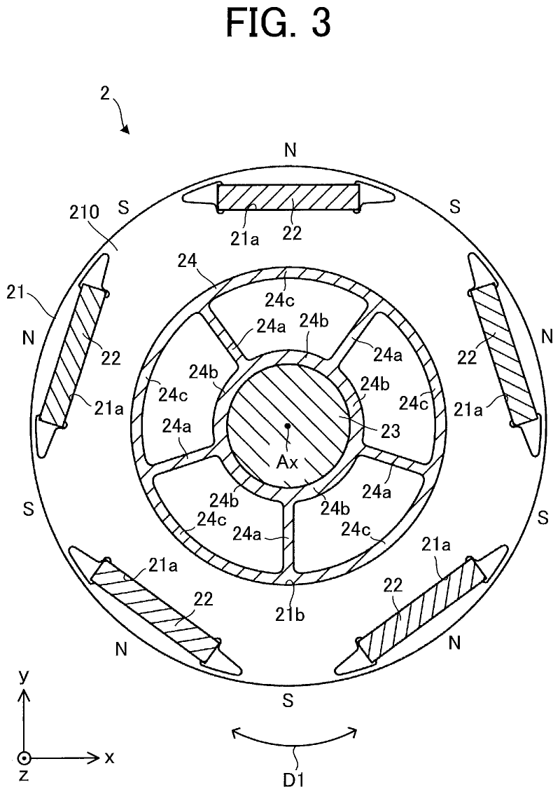

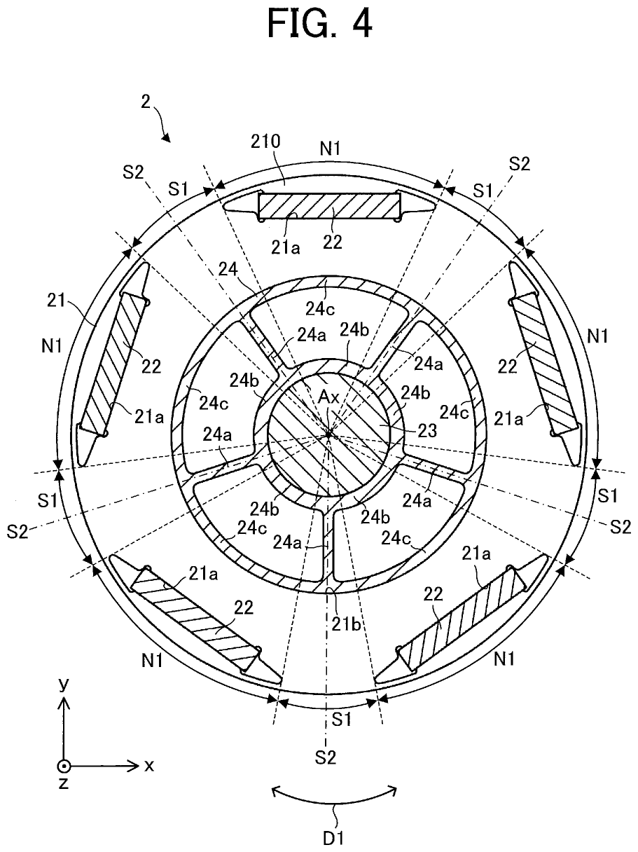

FIGS. 3 and 4 are cross-sectional views schematically illustrating a configuration of the rotor 2. In FIG. 3, “N” represents a north pole of the rotor 2 (specifically a north pole functioning to the stator 3), and “S” represents a south pole of the rotor 2 (specifically a south pole functioning to the stator 3).

The rotor 2 includes a rotor core 21, a plurality of permanent magnets 22, a shaft 23, and a nonmagnetic member 24. The rotor 2 is rotatably disposed inside the stator 3. Specifically, the rotor 2 is disposed at the inner side of the stator 3 such that the permanent magnets 22 face the stator 3. The rotation axis of the rotor 2 coincides with the axis line Ax. An air gap is provided between the rotor core 21 and the stator 3.

The rotor core 21 is composed of a plurality of cores 210 stacked in the axis direction. The rotor core 21 (i.e., the plurality of cores 210) is fixed to the nonmagnetic member 24. The shaft 23 is rotatably held by bearings 7a and 7b. When the motor 1 is driven, the rotor core 21 and the nonmagnetic member 24 rotate together with the shaft 23.

In the axis direction, the rotor core 21 may be longer than the stator core 31. This makes magnetic flux from the rotor 2 (specifically, the permanent magnets 22) efficiently flows into the stator core 31.

The rotor core 21 (i.e., the plurality of cores 210) includes at least one magnet insertion hole 21a and a shaft insertion hole 21b.

In this embodiment, the rotor core 21 includes a plurality of magnet insertion holes 21a, and at least one permanent magnet 22 is disposed in each of the magnet insertion holes 21a.

The rotor core 21 is composed of, for example, a plurality of electromagnetic steel sheets. In this case, each of the plurality of cores 210 is an electromagnetic steel sheet. The plurality of cores 210 may include cores other than electromagnetic steel sheets. For example, the rotor core 21 may be composed of a plurality of iron cores each having a predetermined shape or may be composed of a mixture of a soft magnetic material and a resin.

Each of the cores 210 of the rotor core 21 has a thickness of 0.2 mm to 0.5 mm, for example. The cores 210 of the rotor core 21 are stacked in the axis direction.

The plurality of magnet insertion holes 21a are formed at regular intervals in the circumferential direction of the rotor core 21. In this embodiment, five magnet insertion holes 21a are disposed in the rotor core 21.

The shaft insertion hole 21b is disposed in a center portion of the rotor core 21. The shaft insertion hole 21b penetrates the rotor core 21 in the axis direction. The shaft 23 is disposed in the shaft hole 21b.

The rotor 2 is a consequent pole rotor. That is, the rotor 2 includes a first magnetic pole formed of each permanent magnet 22 and a second magnetic pole that is a pseudo-magnetic pole formed of a part of the rotor core 21 adjacent to each magnet insertion hole 21a in the circumferential direction of the rotor core 21. That is, the second magnetic pole is a pseudo-magnetic pole formed of a part of the rotor core 21 between adjacent two of the magnet insertion holes 21a.

As illustrated in FIG. 4, the rotor 2 includes a plurality of first magnetic pole regions N1 and a plurality of second magnetic pole regions S1. Each of the first magnetic pole regions N1 is a region between two lines passing through both ends of one magnet insertion hole 21a and the rotation center of the rotor 2 in the xy plane. Similarly, in the xy plane, each of the second magnetic pole regions S1 is a region between two lines passing through one end of each of two adjacent magnet insertion holes 21a and the rotation center of the rotor 2 and is a region adjacent to the first magnetic pole regions N1. That is, each of the first magnetic pole regions N1 is a region including the magnet insertion hole 21a and the permanent magnet 22, and each of the second magnetic pole regions S1 is a region not including the magnet insertion hole 21a and the permanent magnet 22.

Each of the permanent magnets 22 forms a north pole as the first magnetic pole of the rotor 2. A part of the rotor core 21 adjacent to one magnet insertion hole 21a in the circumferential direction of the rotor core 21 forms a south pole as the second magnetic pole that is a pseudo-magnetic pole of the rotor 2. In this case, each of the first magnetic pole regions N1 functions as the first magnetic pole (magnetic pole serving as a north pole to the stator 3 in this embodiment), and each of the second magnetic pole regions S1 functions as the second magnetic pole (pseudo-magnetic pole serving as a north pole to the stator 3 in this embodiment). In other words, each of the first magnetic pole regions N1 functions as a first polarity, and each of the second magnetic pole regions S1 functions as a second polarity different from the first polarity.

The number of permanent magnets 22 is half of the number n (where n is an even number greater than or equal to four) of magnetic poles of the rotor 2. The number n of magnetic poles of the rotor 2 is the sum of the number of magnetic poles functioning as north poles to the stator 3 and the number of magnetic poles functioning as south poles to the stator 3. The north poles and the south poles of the rotor 2 are alternately arranged in the circumferential direction of the rotor 2. In this embodiment, n=10.

The shaft 23 is fixed to the rotor core 21 with the nonmagnetic member 24.

At least one permanent magnet 22 is disposed in each magnet insertion hole 21a. In this embodiment, one permanent magnet 22 is disposed in each magnet insertion hole 21a. Each permanent magnet 22 is, for example, a flat-plate permanent magnet. Each permanent magnet 22 may be, for example, a rare earth magnet containing neodymium or samarium. Each permanent magnet 22 may be a ferrite magnet containing iron. The type of the permanent magnets 22 is not limited to the example of this embodiment, and the permanent magnets 22 may be made of another material.

The permanent magnets 22 in the magnet insertion holes 21a are magnetized in the radial direction and consequently magnetic flux from the permanent magnets 22 flows into the stator 3.

The nonmagnetic member 24 is disposed in the shaft insertion hole 21b. The nonmagnetic member 24 couples the shaft 23 to the rotor core 21.

The nonmagnetic member 24 is made of, for example, a non-magnetic material such as austenitic stainless steel, aluminium, a bulk molding compound (BMC), polybutylene terephthalate (PBT), polyphenylene sulfide (PPS), liquid crystal polymer (LCP), or polyethylene terephthalate (PET).

The nonmagnetic member 24 is, for example, a resin. In this case, the nonmagnetic member 24 is made of a non-magnetic resin such as a bulk molding compound (BMC), polybutylene terephthalate (PBT), polyphenylene sulfide (PPS), liquid crystal polymer (LCP), polyethylene terephthalate (PET).

The nonmagnetic member 24 has a linear expansion coefficient larger than that of the rotor core 21. Examples of the linear expansion coefficient include:

electromagnetic steel sheet: 1.08×10⁻⁵ (1/degC)

austenitic stainless steel: 1.63×10⁻⁵ (1/degC)

aluminium: 2.36×10⁻⁵ (1/degC)

bulk molding compound (BMC): 1.5×10⁻⁵ (1/degC) to 3.0×10⁻⁵ (1/degC)

polybutylene terephthalate (PBT): 2×10⁻⁵ (1/degC) to 9×10⁻⁵ (1/degC)

polyphenylene sulfide (PPS): 4.9×10⁻⁵ (1/degC)

polyethylene terephthalate (PET): 6.5×10⁻⁵ (1/degC)

The nonmagnetic member 24 has an elastic modulus smaller than that of the rotor core 21. Examples of the elastic modulus include:

electromagnetic steel sheet: 230 MPa

austenitic stainless steel: 197 MPa

aluminium: 72 MPa

bulk molding compound (BMC): 140 MPa

polybutylene terephthalate (PBT): 80 MPa

polyphenylene sulfide (PPS): 110 MPa

polyethylene terephthalate (PET): 100 MPa

The nonmagnetic member 24 includes at least one beam 24a extending from the shaft 23 to the second magnetic pole regions S1. In the example illustrated in FIGS. 3 and 4, the nonmagnetic member 24 includes a plurality of beams 24a (specifically, five beams 24a). The five beams 24a radially extend from the shaft 23. In the rotor 2, there are no beams extending from the shaft 23 to the first magnetic pole regions N1. That is, the rotor 2 includes no beams in contact with the rotor core 21 in the first magnetic pole regions N1.

It is sufficient that each beam 24a is located between two lines passing through one end of each of two adjacent magnet insertion holes 21a and the rotation center of the rotor 2 in the xy plane. That is, it is sufficient that the beams 24a are located in the second magnetic pole regions S1. In the example illustrated in FIGS. 3 and 4, in the xy plane, each beam 24a is located on a line S2 passing through the center of the corresponding second magnetic pole region S1 and the rotation center of the rotor 2. Each line S2 is a magnetic pole center line passing through the second magnetic pole.

The nonmagnetic member 24 may also include at least one shaft cover 24b covering an outer peripheral surface of the shaft 23 and at least one core cover 24c covering an inner peripheral surface of the rotor core 21. In this case, the shaft cover 24b and the core cover 24c are connected to the beams 24a. A region surrounded by the beams 24a, the shaft cover 24b, and the core cover 24c is a gap.

The rotor 2 is not necessarily include the core cover 24c. Even in this case, the nonmagnetic member 24 (specifically, the beams 24a) is in contact with the rotor core 21 in the second magnetic pole regions S1.

The rotor core 21, the shaft 23, and the nonmagnetic member 24 are fixed by, for example, integral molding using a die. In this case, a material (e.g., a resin) of the nonmagnetic member 24 is molded with the die in which the rotor core 21 and the shaft 23 are placed. Consequently, the shaft 23 is fixed to the nonmagnetic member 24 together with the rotor core 21.

### First Variation

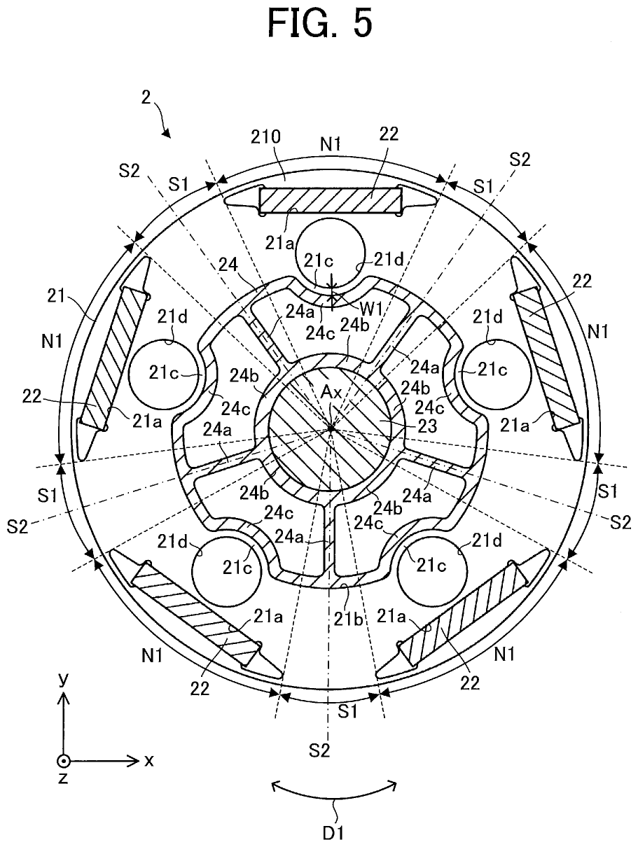

FIG. 5 is a diagram illustrating another example of the rotor 2.

In a first variation, the rotor core 21 includes at least one projection 21c projecting toward the shaft 23. In the example illustrated in FIG. 5, the rotor core 21 includes five projections 21c. The projections 21c are formed on the inner peripheral surface of the rotor core 21. In this case, the core cover 24c covers the projections 21c.

In the first variation, the rotor core 21 may include at least one gap 21d. In the example illustrated in FIG. 5, the rotor core 21 includes five gaps 21d. Each gap 21d is provided between the magnet insertion hole 21a and the projection 21c, and faces the projection 21c. In the xy plane, a minimum width W1 of each projection 21c is greater than or equal to one time and less than or equal to twice as large as the thickness of the core 210. In the xy plane, the minimum width W1 of each projection 21c may be greater than or equal to one time and less than or equal to four times as large as the thickness of the core 210. In the first variation, the thickness of the core 210 is, for example, 0.35 mm, and the minimum width W1 of each projection 21c is, for example, 0.60 mm.

### Second Variation

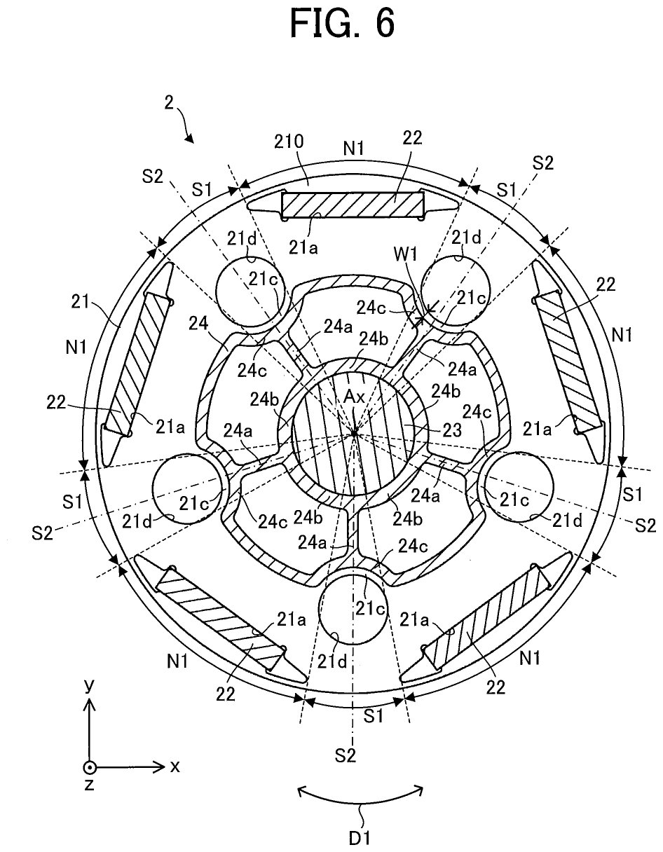

FIG. 6 is a diagram illustrating yet another example of the rotor 2.

In the second variation, the rotor core 21 includes at least one gap 21d. Each gap 21d faces the projection 21c, and each beam 24a is located on a line passing through the gap 21d and the rotation center of the rotor 2. In the example illustrated in FIG. 6, the line passing through the gap 21d and the rotation center of the rotor 2 is a line S2. Thus, each beam 24a and the corresponding gap 21d are located on the line S2. In the xy plane, the minimum width W1 of the projections 21c is the same as that in the first variation.

### Third Variation

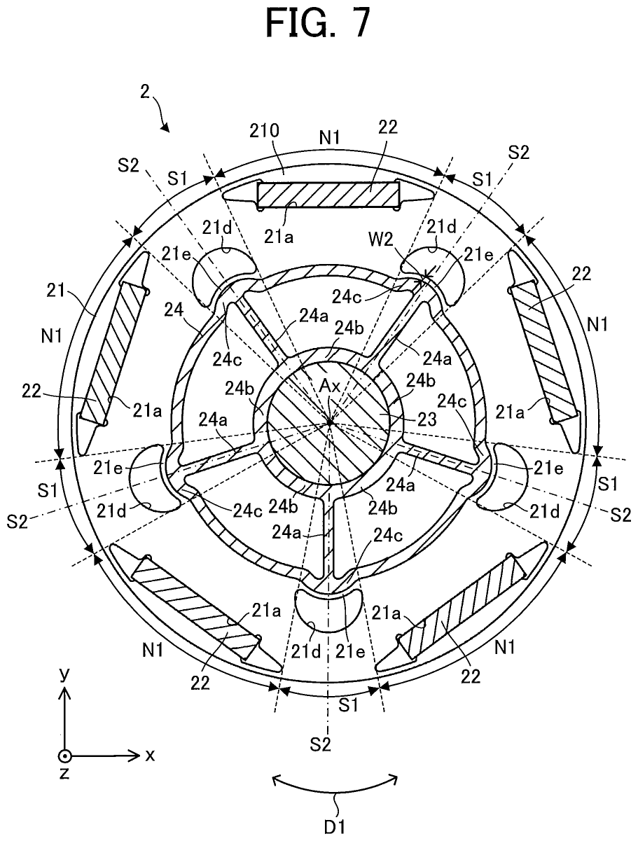

FIG. 7 is a diagram illustrating yet another example of the rotor 2.

In a third variation, the rotor core 21 includes at least one recess 21e recessed toward the outer peripheral surface of the rotor core 21. In the example illustrated in FIG. 7, the rotor core 21 includes five recesses 21e. The recesses 21e are formed on the inner peripheral surface of the rotor core 21. In this case, the core cover 24c covers the recesses 21e.

In the third variation, the rotor core 21 may include at least one gap 21d. In the example illustrated in FIG. 7, the rotor core 21 includes five gaps 21d. Each gap 21d is provided between the magnet insertion hole 21a and the recess 21e, and faces the recess 21e. In the xy plane, a minimum width W2 of each recess 21e is greater than or equal to one time and less than or equal to twice as large as the thickness of the core 210. In the xy plane, the minimum width W2 of each recess 21e may be greater than or equal to one time and less than or equal to four times as large as the thickness of the core 210. In the third variation, the thickness of the core 210 is, for example, 0.35 mm, and the minimum width W2 of each recess 21e is, for example, 0.60 mm.

In the third variation, each gap 21d faces the recess 21e, and each beam 24a is located on a line passing through the corresponding gap 21d and the rotation center of the rotor 2. In the example illustrated in FIG. 7, the line passing through the gap 21d and the rotation center of the rotor 2 is the line S2. Thus, each beam 24a and the corresponding gap 21d are located on the line S2.

### Fourth Variation

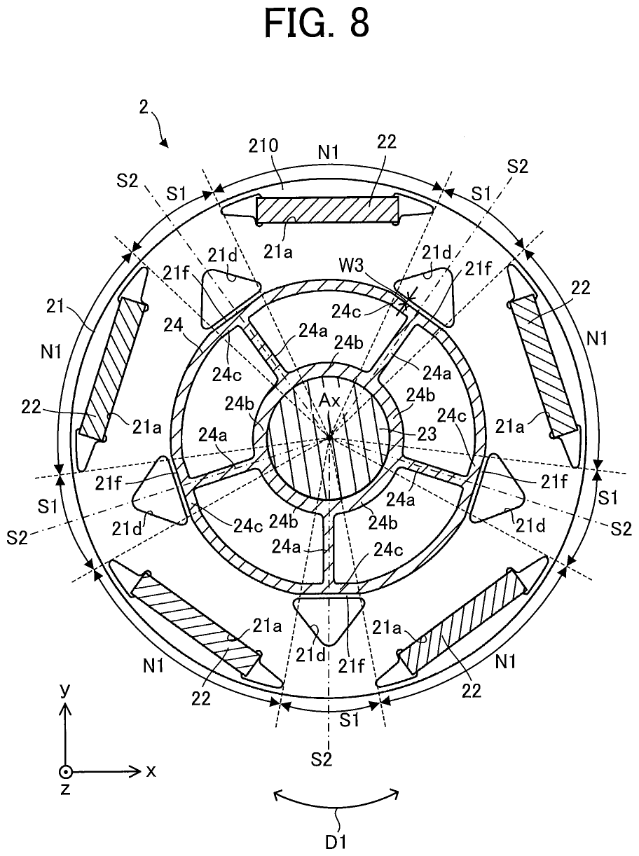

FIG. 8 is a diagram illustrating yet another example of the rotor 2.

In a fourth variation, the rotor core 21 includes at least one gap 21d and at least one extension 21f facing the gap 21d. In the example illustrated in FIG. 8, the rotor core 21 includes five gaps 21d and five extensions 21f.

Each of the extensions 21f extends straight in the xy plane. For example, in the xy plane, each extension 21f faces the corresponding beam 24a, and is perpendicular to this beam 24a. The extensions 21f are formed on the inner peripheral surface of the rotor core 21. In this case, the core cover 24c covers the extensions 21f.

In the xy plane, a shape of each of the gaps 21d may be triangular. In this case, in the xy plane, one side of each gap 21d is parallel to the extensions 21f.

In the xy plane, a minimum width W3 of each extension 21f is greater than or equal to one time and less than or equal to twice as large as the thickness of the core 210. In the xy plane, the minimum width W3 of each extension 21f may be greater than or equal to one time and less than or equal to four times as large as the thickness of the core 210. In the fourth variation, the thickness of the core 210 is, for example, 0.35 mm, and the minimum width W3 of each extension 21f is, for example, 0.60 mm.

### <Advantages of Rotor 2>

Advantages of the rotor 2 will now be described.

In a consequent pole rotor, magnetic flux generally easily flows from the permanent magnets 22 into the shaft 23. As magnetic flux (i.e., magnetic flux leakage) flowing from the permanent magnets 22 into the shaft 23 increases, efficiency of the rotor 2 decreases. On the other hand, in this embodiment, the nonmagnetic member 24 is disposed in the shaft insertion hole 21b. Thus, magnetic flux leakage flowing from the permanent magnets 22 into the shaft 23 can be reduced. As a result, a decrease in efficiency of the rotor 2 can be prevented.

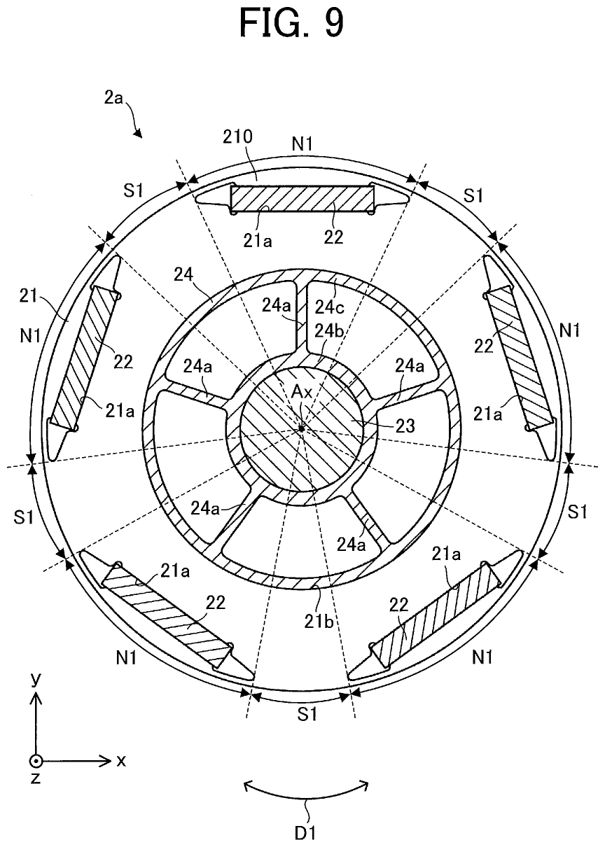

FIG. 9 is a cross-sectional view illustrating a rotor 2a as a comparative example.

In the rotor 2a as the comparative example, the beams 24a extend from the shaft 23 to the first magnetic pole regions N1. In this case, when the beams 24a expand because of a temperature change, stress is concentrated on the rotor core 21 between the beams 24a and the permanent magnets 22. In particular, in a case where the nonmagnetic member 24 has a linear expansion coefficient larger than that of the rotor core 21, stress due to expansion of the beams 24a tends to be concentrated on regions facing the magnet insertion holes 21a. Consequently, the magnet insertion holes 21a might be deformed, and thus the permanent magnets 22 disposed in the magnet insertion holes 21a are damaged.

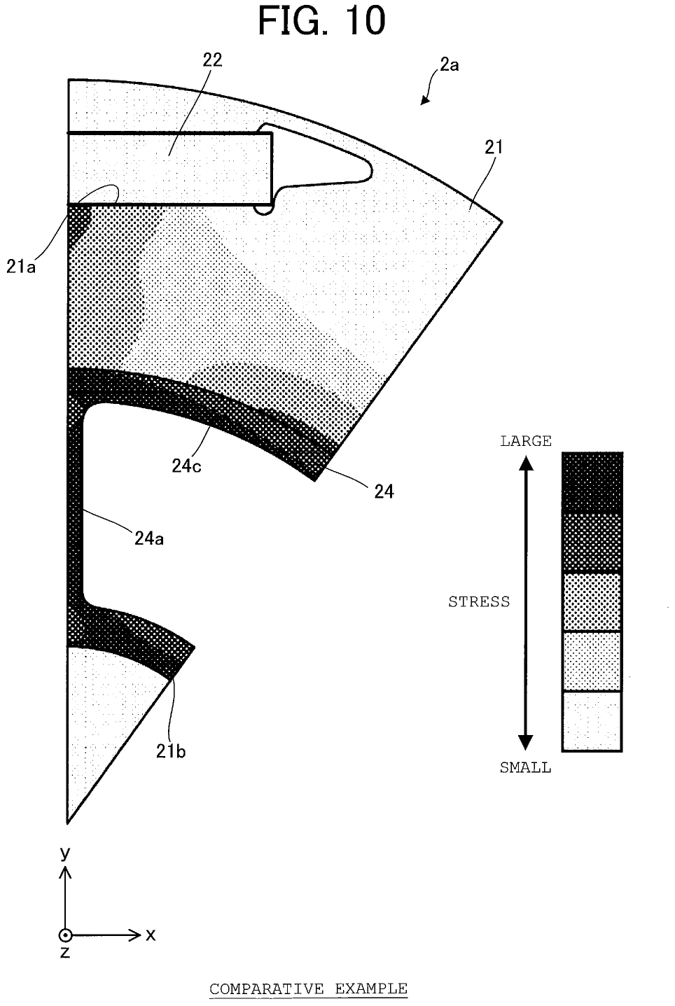

FIG. 10 is a diagram illustrating stress occurring in the rotor core 21 when the beams 24a expand in the rotor 2a as the comparative example. FIG. 10 shows a part of region of the rotor 2a.

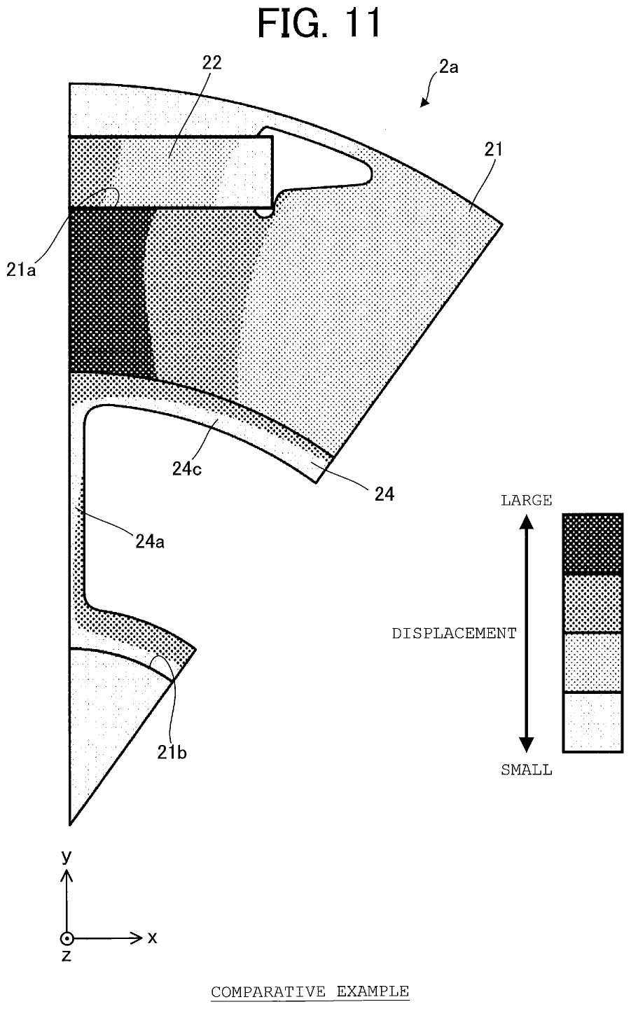

FIG. 11 is a diagram showing displacement of the rotor core 21 when the beam 24a expand in the rotor 2a as the comparative example. FIG. 11 shows the region illustrated in FIG. 10.

As illustrated in FIG. 10, in the rotor 2a as the comparative example, stress due to expansion of the beams 24a is concentrated on regions facing the magnet insertion holes 21a. Consequently, as illustrated in FIG. 11, the regions facing the magnet insertion holes 21a are significantly displaced. That is, the regions between the beams 24a and the magnet insertion holes 21a are deformed outward in the radial direction. In this case, the inner walls of the magnet insertion holes 21a might be strongly brought into contact with the permanent magnets 22, and thus the permanent magnets 22 are damaged.

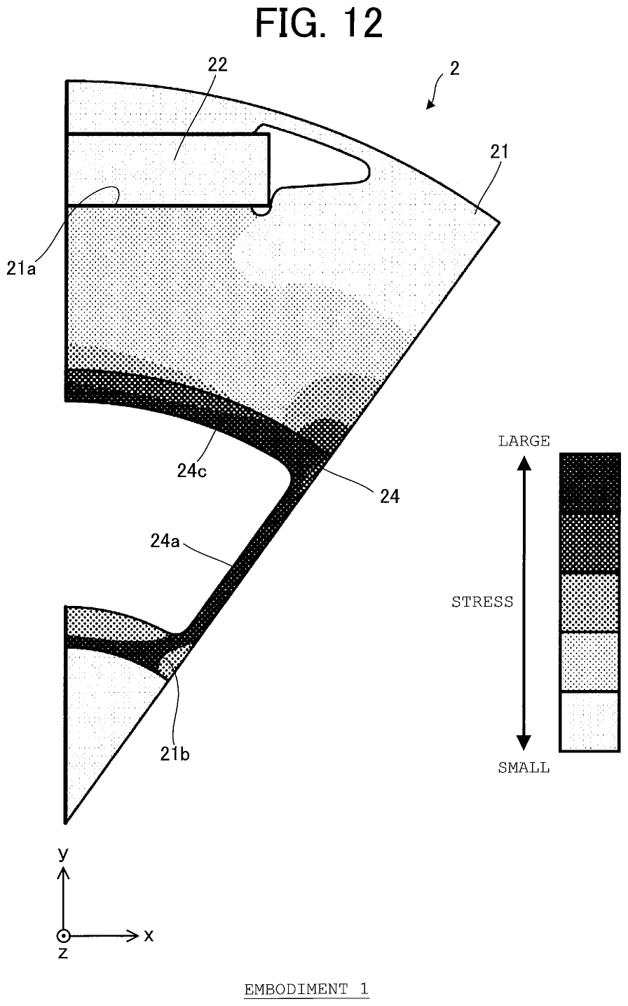

FIG. 12 is a diagram illustrating stress occurring in the rotor core 21 when the beams 24a expand in the rotor 2 in the first embodiment. FIG. 12 shows a part of region of the rotor 2.

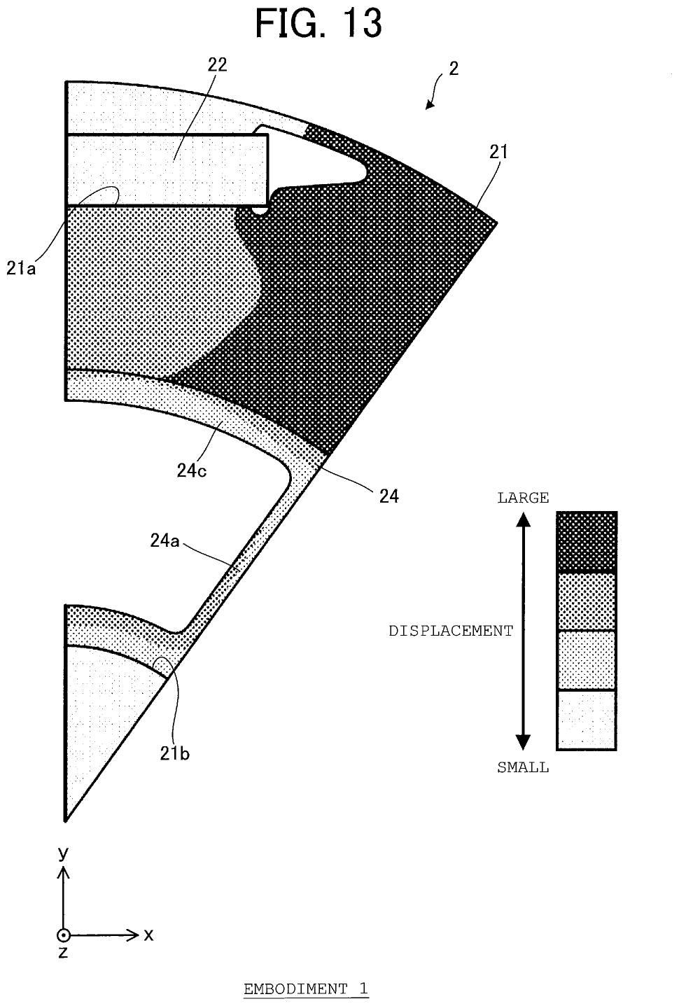

FIG. 13 is a diagram illustrating displacement of the rotor core 21 when the beams 24a expand in the rotor 2 in the first embodiment. FIG. 13 shows the region illustrated in FIG. 12.

In this embodiment, the beams 24a extend from the shaft 23 to the second magnetic pole regions S1. In the rotor 2, there are no beams extending from the shaft 23 to the first magnetic pole regions N1. Thus, even when the beams 24a expand because of a temperature change, stress caused by expansion of the beams 24a is not concentrated on regions facing the magnet insertion holes 21a, as illustrated in FIG. 12. Thus, as illustrated in FIG. 13, deformation of the regions between the beams 24a and the magnet insertion holes 21a can be prevented. As a result, deformation of the magnet insertion holes 21a can be prevented, and damage of the permanent magnets 22 disposed in the magnet insertion holes 21a can be avoided.

As illustrated in FIG. 4, in the xy plane, in the case where each beam 24a is located on the line S2 passing through the center of the corresponding second magnetic pole region S1 and the rotation center of the rotor 2, the beam 24a is located at the same distance from two magnet insertion holes 21a. In this case, even when the beams 24a expand because of a temperature change, deformation of the regions between the beams 24a and the magnet insertion holes 21a can be effectively prevented. As a result, deformation of the magnet insertion holes 21a can be prevented, and damage of the permanent magnets 22 disposed in the magnet insertion holes 21a can be effectively avoided.

In a case where the nonmagnetic member 24 has an elastic modulus smaller than that of the rotor core 21, stress due to expansion of the beams 24a is reduced, and deformation of regions between the beams 24a and the magnet insertion holes 21a can be effectively prevented. For example, in a case where the nonmagnetic member 24 is made of a resin, stress due to expansion of the beams 24a is reduced, as compared to the case where the nonmagnetic member 24 is made of a metal. As a result, deformation of the magnet insertion holes 21a can be prevented, and damage of the permanent magnets 22 disposed in the magnet insertion holes 21a can be effectively avoided.

In addition, in the case where the nonmagnetic member 24 is made of a resin, the rotor 2 can be molded by integral molding using a die. Thus, as compared to techniques such as press fitting, caulking, and shrink fitting, fabrication steps of the rotor 2, such as a fixing step of the shaft 23, can be simplified.

The variations described above have the advantages described in the present embodiment. In addition to the advantages described in the present embodiment, the variations described above have advantages as follows:

In the first and second variations, the core cover 24c covers the projections 21c. Accordingly, it is possible to prevent the shaft 23 coupled to the nonmagnetic member 24 from shifting in the circumferential direction relative to the rotor core 21.

In the xy plane, in the case where the minimum width W1 of each projection 21c is greater than or equal to one time and less than or equal to four times as large as the thickness of the core 210, processing by punching is easy, and the projections 21c can be easily deformed in the radial direction. When the expansion of the beams 24a occurs, stress due to the expansion of the beams 24a is absorbed by deformation of the projections 21c. Thus, even when the beams 24a expand because of a temperature change, deformation of the magnet insertion holes 21a can be prevented, and damage of the permanent magnets 22 disposed in the magnet insertion holes 21a can be avoided. In particular, in the case where the minimum width W1 of each projection 21c is greater than or equal to one time and less than or equal to twice as large as the thickness of the core 210, deformation of the magnet insertion holes 21a can be effectively prevented, and damage of the permanent magnets 22 disposed in the magnet insertion holes 21a can be effectively avoided.

In the third variation, the core cover 24c covers the recess 21e. Accordingly, it is possible to prevent the shaft 23 coupled to the nonmagnetic member 24 from shifting in the circumferential direction relative to the rotor core 21.

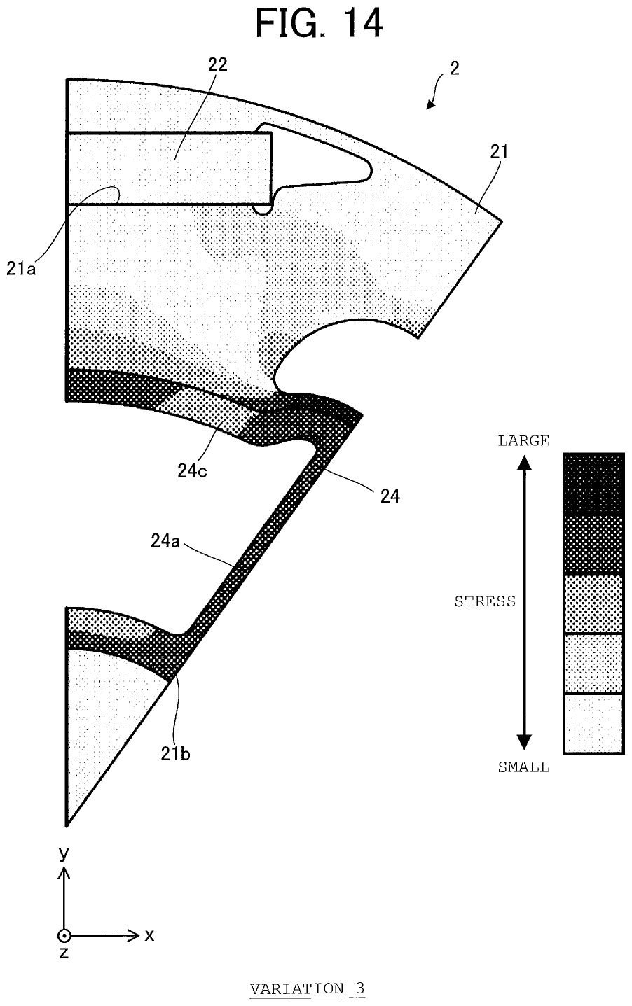

FIG. 14 is a diagram illustrating stress occurring in the rotor core 21 when the beams 24a expand in the rotor 2 in the third variation. FIG. 14 shows a part of region of the rotor 2.

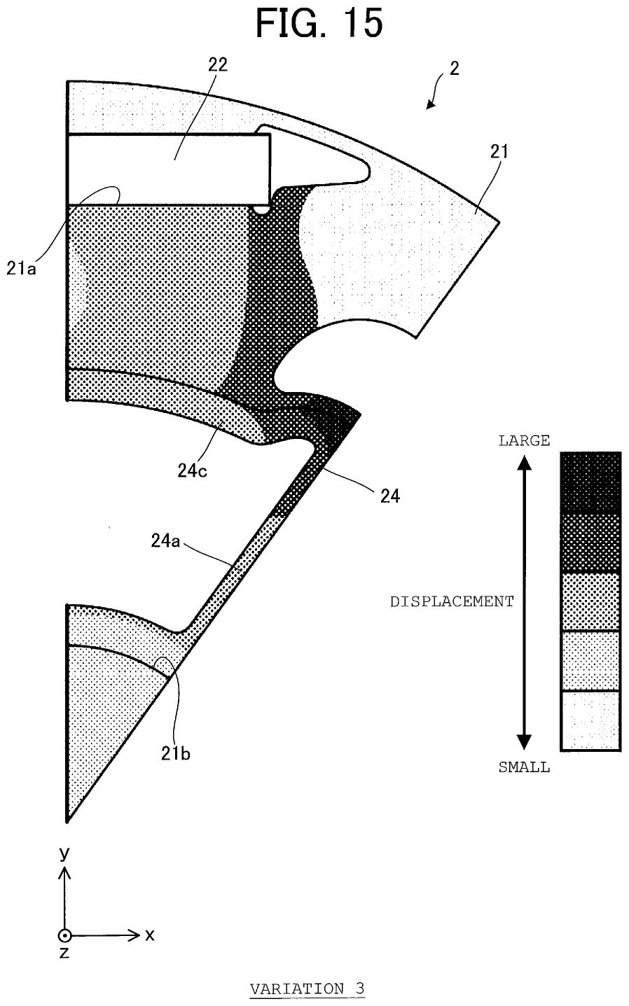

FIG. 15 is a diagram illustrating displacement of the rotor core 21 when the beams 24a expand in the rotor 2 in the third variation. FIG. 15 shows the region illustrated in FIG. 14.

In the xy plane, in the case where the minimum width W2 of each recess 21e is greater than or equal to one time and less than or equal to four times as large as the thickness of the core 210, the recesses 21e can be easily deformed in the radial direction. In particular, in a case where the minimum width W2 of recess 21e is greater than or equal to one time and less than or equal to two times as large as the thickness of the core 210, the recess 21e can be more easily deformed in the radial direction. When the beam 24a expands, stress due to expansion of the beam 24a is absorbed by deformation of the recess 21e, as illustrated in FIGS. 14 and 15. Thus, even when the beam 24a expands because of a temperature change, deformation of the magnet insertion hole 21a can be prevented, and damage of the permanent magnet 22 disposed in the magnet insertion hole 21a can be avoided.

In the fourth variation, the core cover 24c covers the extension 21f. In this case, in a manner similar to the first through third variations, it is also possible to prevent the shaft 23 coupled to the nonmagnetic member 24 from shifting in the circumferential direction relative to the rotor core 21. In addition, in the xy plane, in the case where the minimum width W3 of extension 21f is greater than or equal to one time and less than or equal to four times as large as the thickness of the core 210, processing by punching is easy, and the extension 21f can be easily deformed in the radial direction. When the beam 24a expands, stress due to expansion of the beam 24a is absorbed by deformation of the extension 21f. Thus, even when the beam 24a expands because of a temperature change, deformation of the magnet insertion hole 21a can be prevented, and damage of the permanent magnet 22 disposed in the magnet insertion hole 21a can be avoided. In particular, in the case where the minimum width W3 of the extension 21f is greater than or equal to one time and less than or equal to twice as large as the thickness of the core 210, deformation of the magnet insertion hole 21a can be effectively prevented, and damage of the permanent magnet 22 disposed in the magnet insertion hole 21a can be effectively avoided.

### Second Embodiment

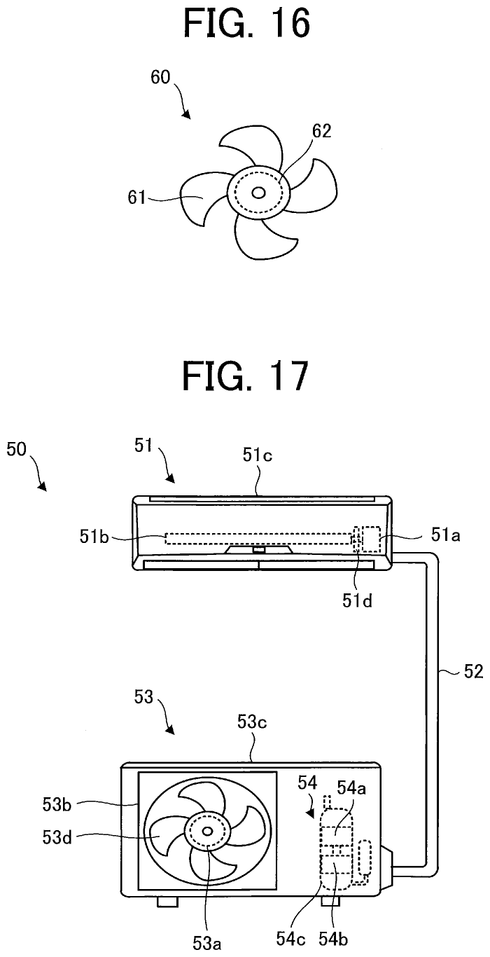

FIG. 16 is a diagram schematically illustrating a configuration of a fan 60 according to a second embodiment.

The fan 60 includes fans 61 and a motor 62. The fan 60 is also referred to as an air blower. The motor 62 is the motor 1 according to the first embodiment. The blade 61 is fixed to a shaft of the motor 62. The motor 62 drives the blades 61. Specifically, the motor 62 causes the blades 61 to rotate. When the motor 62 is driven, the blades 61 rotate to generate an airflow. In this manner, the fan 60 is capable of sending air.

In the fan 60 according to the second embodiment, the motor 1 described in the first embodiment is applied to the motor 62, and thus, the same advantages as those described in the first embodiment can be obtained. In addition, a decrease in efficiency of the fan 60 can be prevented.

### Third Embodiment

An air conditioner 50 (also referred to as a refrigeration air conditioning apparatus or a refrigeration cycle apparatus) according to a third embodiment will be described.

FIG. 17 is a diagram schematically illustrating a configuration of the air conditioner 50 according to the third embodiment.

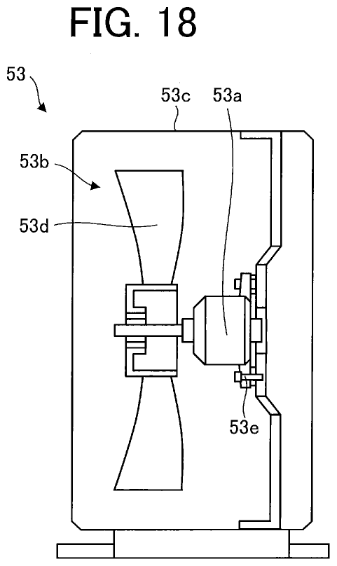

FIG. 18 is a diagram schematically illustrating main components in an outdoor unit 53 as an air blower of the air conditioner 50.

The air conditioner 50 according to the third embodiment includes an indoor unit 51 as an air blower (first air blower), a refrigerant pipe 52, and an outdoor unit 53 as an air blower (second air blower) connected to the indoor unit 51. For example, the outdoor unit 53 is connected to the indoor unit 51 through the refrigerant pipe 52.

The indoor unit 51 includes a motor 51a (e.g., the motor 1 according to the first embodiment), an air blowing unit 51b that supplies air when being driven by the motor 51a, and a housing 51c covering the motor 51a and the air blowing unit 51b. The air blowing unit 51b includes, for example, blades 51d that are driven by the motor 51a. For example, the blades 51d are fixed to a shaft of the motor 51a, and generate an airflow.

The outdoor unit 53 includes a motor 53a (e.g., the motor 1 according to the first embodiment), an air blowing unit 53b, a compressor 54, a heat exchanger (not shown), and a housing 53c covering the air blowing unit 53b, the compressor 54, and the heat exchanger. When the air blowing unit 53b is driven by the motor 53a, the air blowing unit 53b supplies air. The air blowing unit 53b includes, for example, blades 53d that are driven by the motor 53a. For example, the blades 53d are fixed to a shaft of the motor 53a, and generate an airflow. The compressor 54 includes a motor 54a (e.g., the motor 1 according to the first embodiment), a compression mechanism 54b (e.g., a refrigerant circuit) that is driven by the motor 54a, and a housing 54c covering the motor 54a and the compression mechanism 54b.

In the air conditioner 50, at least one of the indoor unit 51 or the outdoor unit 53 includes the motor 1 described in the first embodiment. That is, one or both of the indoor unit 51 and the outdoor unit 53 include the motor 1 described in the first embodiment. Specifically, as a driving source of an air blowing unit, the motor 1 described in the first embodiment is applied to at least one of the motors 51a or 53a. That is, the motor 1 described in the first embodiment is applicable to one or both of the indoor unit 51 and the outdoor unit 53. The motor 1 described in the first embodiment may be applied to the motor 54a of the compressor 54.

The air conditioner 50 is capable of performing air conditioning such as a cooling operation of sending cold air and a heating operation of sending warm air from the indoor unit 51, for example. In the indoor unit 51, the motor 51a is a driving source for driving the air blowing unit 51b. The air blowing unit 51b is capable of sending conditioned air.

As illustrated in FIG. 18, in the outdoor unit 53, the motor 53a is fixed to the housing 53c of the outdoor unit 53 by screws 53e, for example.

In the air conditioner 50 according to the third embodiment, the motor 1 described in the first embodiment is applied to at least one of the motors 51a or 53a, and thus, the same advantages as those described in the first embodiment can be obtained. As a result, a decrease in efficiency of the air conditioning apparatus 50 can be prevented.

Furthermore, with the use of the motor 1 according to the first embodiment as a driving source of an air blower (e.g., the indoor unit 51), the same advantages as those described in the first embodiment can be obtained. As a result, a decrease in air blower efficiency can be prevented. The blower including the motor 1 according to the first embodiment and the blades (e.g., the blades 51d or 53d) driven by the motor 1 can be used alone as a device for supplying air. This blower is also applicable to equipment except for the air conditioner 50.

Furthermore, in the case of using the motor 1 according to the first embodiment as a driving source of the indoor unit 54, the same advantages as those described in the first embodiment can be obtained. As a result, a decrease in efficiency of the compressor 54 can be prevented.

The motor 1 described in the first embodiment can be mounted on equipment including a driving source, such as a ventilator, a household electrical appliance, or a machine tool, as well as the air conditioner 50.

Features of the embodiments and features of the variations described above can be combined as appropriate.

1. A consequent pole rotor comprising:
a rotor core having a magnet insertion hole and a shaft insertion hole;
a permanent magnet disposed in the magnet insertion hole;
a first magnetic pole region including the magnet insertion hole and functioning as a first magnetic pole;
a second magnetic pole region adjacent to the first magnetic pole region and functioning as a second magnetic pole, the second magnetic pole being a pseudo-magnetic pole;
a shaft disposed in the shaft insertion hole; and
a nonmagnetic member disposed in the shaft insertion hole, having a linear expansion coefficient larger than a linear expansion coefficient of the rotor core, and coupling the shaft to the rotor core, wherein
the nonmagnetic member includes a beam extending from the shaft to the second magnetic pole region.

2. The consequent pole rotor according to claim 1, wherein in a plane orthogonal to an axis direction of the consequent pole rotor, the beam is located on a line passing through a center of the second magnetic pole region and a rotation center of the consequent pole rotor.

3. The consequent pole rotor according to claim 1, wherein
the rotor core is formed on an inner peripheral surface of the rotor core and includes a projection projecting toward the shaft, and
the nonmagnetic member includes a core cover connected to the beam and covering the projection.

4. The consequent pole rotor according to claim 3, wherein
the rotor core has a gap facing the projection, and
the beam is located on a line passing through the gap and a rotation center of the consequent pole rotor.

5. The consequent pole rotor according to claim 3, wherein
the rotor core is composed of a plurality of cores stacked in the axis direction of the consequent pole rotor, and
in a plane orthogonal to the axis direction of the consequent pole rotor, a minimum width of the projection is greater than or equal to one time and less than or equal to twice as large as a thickness of the core.

6. The consequent pole rotor according to claim 1, wherein
the rotor core is formed on an inner peripheral surface of the rotor core, and has a recess that is recessed toward an outer peripheral surface of the rotor core, and
the nonmagnetic member includes a core cover connected to the beam and covering the recess.

7. The consequent pole rotor according to claim 6, wherein
the rotor core includes a gap facing the recess, and
the beam is located on a line passing through the gap and a rotation center of the consequent pole rotor.

8. The consequent pole rotor according to claim 6, wherein
the rotor core is composed of a plurality of cores stacked in the axis direction of the consequent pole rotor, and
in a plane orthogonal to the axis direction of the consequent pole rotor, a minimum width of the recess is greater than or equal to one time and less than or equal to twice as large as a thickness of the core.

9. The consequent pole rotor according to claim 1, wherein
the rotor core includes a gap and an extension, the extension facing the gap and being formed on an inner peripheral surface of the rotor core, and
in a plane orthogonal to an axis direction of the consequent pole rotor, the extension faces the beam and is orthogonal to the beam.

10. The consequent pole rotor according to claim 1, wherein the nonmagnetic member is a resin.

11. The consequent pole rotor according to claim 1, wherein the nonmagnetic member has an elastic modulus smaller than an elastic modulus of the rotor core.

12. A motor comprising:
the consequent pole rotor according to claim 1; and
a stator disposed outside the consequent pole rotor.

13. A fan comprising:
a blade; and
the motor according to claim 12 to drive the blade.

14. An air conditioner comprising:
an indoor unit; and
an outdoor unit connected to the indoor unit, wherein
one or both of the indoor unit and the outdoor unit include the motor according to claim 12.

15. The consequent pole rotor according to claim 2, wherein
the rotor core is formed on an inner peripheral surface of the rotor core and includes a projection projecting toward the shaft, and
the nonmagnetic member includes a core cover connected to the beam and covering the projection.

16. The consequent pole rotor according to claim 4, wherein
the rotor core is composed of a plurality of cores stacked in the axis direction of the consequent pole rotor, and
in a plane orthogonal to the axis direction of the consequent pole rotor, a minimum width of the projection is greater than or equal to one time and less than or equal to twice as large as a thickness of the core.

17. The consequent pole rotor according to claim 2, wherein
the rotor core is formed on an inner peripheral surface of the rotor core, and has a recess that is recessed toward an outer peripheral surface of the rotor core, and
the nonmagnetic member includes a core cover connected to the beam and covering the recess.

18. The consequent pole rotor according to claim 7, wherein
the rotor core is composed of a plurality of cores stacked in the axis direction of the consequent pole rotor, and
in a plane orthogonal to the axis direction of the consequent pole rotor, a minimum width of the recess is greater than or equal to one time and less than or equal to twice as large as a thickness of the core.

19. The consequent pole rotor according to claim 2, wherein
the rotor core includes a gap and an extension, the extension facing the gap and being formed on an inner peripheral surface of the rotor core, and
in a plane orthogonal to an axis direction of the consequent pole rotor, the extension faces the beam and is orthogonal to the beam.
